(19) United States
(12) Patent Application Publication
(10) Pub. No.: US 2026/0212522 A1
(43) Pub. Date: Jul. 23, 2026

(54) LIGHTWEIGHT SIMULTANEOUS LOCATION AND MAPPING ON SPACECRAFT TO DETERMINE STRUCTURE AND POSE

(71) Applicant: Southwest Research Institute, San Antonio, TX (US)

(72) Inventors: Ryan MCBEE, San Antonio, TX (US); David R. CHAMBERS, Chickasha, OK (US)

(21) Appl. No.: 19/032,565

(22) Filed: Jan. 21, 2025

(51) Int. Cl. G06T 7/593; G06T 5/20; G06T 5/50; G06T 7/13; G06T 7/285; G06T 7/33; G06T 7/38; G06T 7/579; G06T 7/73

(52) U.S. Cl. CPC G06T 7/593; G06T 5/20; G06T 5/50; G06T 7/13; G06T 7/285; G06T 7/344; G06T 7/38; G06T 7/579; G06T 7/75; G06T 2207/10012; G06T 2207/10032

(57) ABSTRACT

In an approach to lightweight simultaneous location and mapping (SLAM) on spacecraft to determine structure and pose, a system includes: one or more image capture devices; a buffer memory; a computing device; image processing circuitry; and odometry optimization circuitry. The system is configured to: receive a plurality of synchronized images from each of the one or more image capture devices; convert the plurality of synchronized images into a plurality of pairs of stereo images; perform stereo matching of the plurality of pairs of stereo images; extract edges from the plurality of pairs of stereo images; and align a current frame to a previous frame.

### FIELD

The present disclosure relates generally to machine vision and, more particularly, to a system and method for lightweight simultaneous location and mapping (SLAM) on spacecraft to determine structure and pose.

### BACKGROUND

In recent years, the need for greater autonomy in space has increased as space operations have become more complex and varied. Some of these advanced operations include In Space Assembly and Manufacturing (ISAM), servicing of spacecraft, and autonomous navigation of rovers. All these operations rely on real-time perception and understanding of their surroundings to accomplish these complex operations in an autonomous manner.

Advanced perception for these applications can be achieved using Simultaneous Localization And Mapping (SLAM) algorithms. SLAM algorithms are commonly used in terrestrial robotics systems to help map an environment and localize the robot in its newly mapped environment. These systems use a variety of different sensors in the SLAM algorithms including cameras, lidars, inertial measurement units (IMU), and sonars. Most SLAM-based algorithms, however, have been designed for the needs of terrestrial ground and aerial vehicles and are not well suited for operations in space. Adapting visual SLAM algorithms for space incurs challenges which may include, but are not limited to, difficulty collecting sufficient relevant data to develop and evaluate the algorithm, lack of distinct features in space environments to use traditional indirect based SLAM approaches, and constraints on computational resources used in the space environment.

### BRIEF DESCRIPTION OF THE DRAWINGS

Reference should be made to the following detailed description which should be read in conjunction with the following figures, wherein like numerals represent like parts.

FIG. 1 is a functional block diagram illustrating a system for lightweight simultaneous location and mapping on spacecraft to determine structure and pose consistent with the present disclosure.

FIG. 2 is an example of attempting to match two consecutive satellite images using a standard indirect algorithm scale-invariant feature transform (SIFT) with brute force matching.

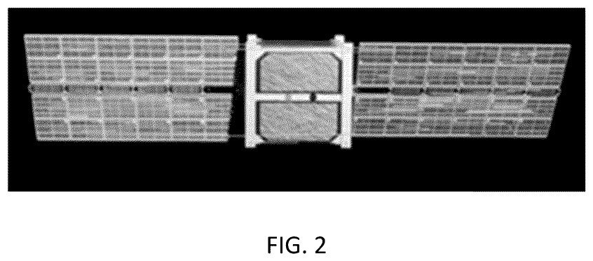

FIGS. 3A-3D are an example of depth estimation using a stereo block matching algorithm consistent with the present disclosure.

FIG. 4 is a functional block diagram of an illustrative example embodiment of a visual odometry circuitry for the system of FIG. 1 consistent with the present disclosure.

FIG. 5 illustrates the results of the SLAM algorithm disclosed herein running on a simulated video with a resolution of 1920×1080 pixels of a satellite with constant rotation.

FIG. 6 is an example of a satellite with its solar panels at a minimal profile.

FIG. 7 illustrates the results from running the disclosed SLAM algorithm on data collected from a ground vehicle driving around a building.

FIG. 8 is a flowchart diagram depicting operations for lightweight simultaneous location and mapping on spacecraft to determine structure and pose, on the system of FIG. 1, consistent with the present disclosure.

FIG. 9 is a block diagram depicting components of one example of the computing device suitable for lightweight simultaneous location and mapping on spacecraft to determine structure and pose, within the system of FIG. 1, consistent with the present disclosure.

### DETAILED DESCRIPTION

The goal of the disclosed Simultaneous Location and Mapping (SLAM) system is to advance perception capabilities for autonomous resident space object (RSO) characterization, on-orbit refueling, active debris mitigation, enabling maneuver without regret, and other in space servicing, assembly, and manufacturing (ISAM) activities. The disclosed SLAM system accurately tracks the orientation and rotation of an RSO using a constrained size, weight, and power (cSWAP) processor on a broad and challenging range of training data. To accomplish this goal the disclosed SLAM was developed with computing and sensing capabilities that identify and track the pose and trajectory of RSOs. To study vision systems in space, terrestrial technologies used in automated vehicles and industrial robotics were evaluated. Most terrestrial applications leverage computationally expensive algorithms; however, the processors available for use in space have significantly reduced processing capacity.

Disclosed herein are multiple novel techniques to enable SLAM for a space environment. For the issue of limited data, photorealistic simulations as well as selective real world example images were used to create a full and robust dataset for algorithmic evaluation. To address the lack of unique features on artificial space objects, a sparse-direct visual SLAM algorithm is employed which relies on optimizing lighting intensities between images to calculate location and mapping instead of relying on indirect features that rely on matching unique texture regions which are limited in a space environment. Finally, to address the issue of limited computational resources, major portions of the sparse-direct visual SLAM algorithm were implemented in optimized circuitry rated for use in space applications, for example, space-grade Field Programmable Gate Array (FPGA) logic.

The localization part of SLAM is responsible for estimating the x, y, z location as well as the rotation about the x, y, and z axes. Having exact and precise localization is essential for precision operations in space such as manufacturing and servicing. The other part of SLAM is the mapping algorithm. The mapping algorithm is responsible for creating an accurate 3D map of the environment over time which can be used for future navigation or reorienting when a previously observed location is encountered.

This disclosure focuses on the localization portion of SLAM, which tracks the absolute location and rotation given a stationary reference point as well as relative position information for an observing spacecraft with respect to another spacecraft or other moving reference. No prior knowledge of the observed structure or materials is required for proper operation of a SLAM algorithm. The disclosed system uses visual SLAM, which only uses cameras as its primary sensor. A camera-only SLAM algorithm has many advantages in a space environment. Algorithms that operate in space must consider the extreme size, weight, and power (SWAP) constraints imposed on spacecraft. The two most popular sensors used in SLAM are cameras and lidars. Cameras are a passive sensor that takes in light and generates an image that the SLAM can analyze. This is contrasted to lidars which send out pulses of light and measure how long until that light comes back. These pulses of light are generally sent and received by a mechanically rotating housing to produce a 360 view of the environment. This additional mechanical movement comes at the cost of having a greater weight, greater power usage, and greater failure rate compared to a passive sensor like a camera. Because of these limitations with lidars, the disclosed system incorporates a visual SLAM algorithm.

While visual SLAM algorithms have been well explored for terrestrial applications such as autonomous vehicles and drones, these algorithms have been explored less for use in space where the environments differ greatly from the environments found on Earth. This has left a significant gap in understanding for how to adapt visual SLAM algorithms developed on Earth for use in space. There are three major challenges in using visual SLAM algorithms designed for earth environments and adapting them for space applications. These limitations are difficulty collecting sufficient relevant data to develop and evaluate the algorithm, lack of distinct features in space environments to use traditional indirect based SLAM approaches, and constraints on computational resources used in the space environment. Disclosed herein are novel solutions to the three problems proposed here with a real time implementation on space rated hardware of the major parts of the visual SLAM algorithm.

Disclosed is a vision system capable of tracking a non-cooperative satellite to service it in space. It is assumed that no prior knowledge about the satellite is provided ahead of time, which restricts the techniques that can be used but increases the overall generalizability of this approach. Additionally, the computer vision system must be able to run in real time and provide precise enough localization information to allow for the servicing satellite to attach and manipulate the non-cooperative satellite. Due to time constraints during development, simulated data for the satellite was used. To prove usability on real world data, a separate example of running on a real autonomous vehicle was used.

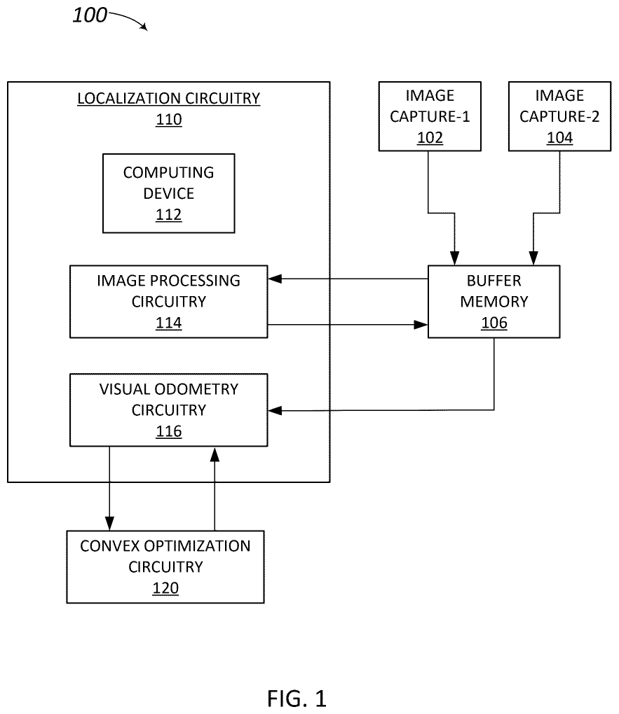

FIG. 1 is a functional block diagram illustrating a system 100 for lightweight SLAM on spacecraft to determine structure and pose consistent with the present disclosure. The system 100 includes image capture-1 102 and image capture-2 104. In an embodiment, the image capture-1 102 and the image capture-2 104 may be a pair of aligned cameras configured to provide a stereo image for calculating the depth of pixels based on how much the pixels in the image have moved from the left and right camera pair. The image capture-1 102 and the image capture-2 104 are communicatively coupled with a buffer memory 106. The buffer memory 106 may be, for example, a synchronous dynamic random-access memory (SDRAM).

The system 100 also includes a localization circuitry 110 communicatively coupled with the buffer memory 106. The localization circuitry 110 generally calculates a depth map from the stereo pair of images, a clipped x/y gradient, and calculates candidate edge locations using the gradient and depth map as input in deciding which sparse set of pixels to select from. In an embodiment, the localization circuitry 110 includes computing device 112, image processing circuitry 114, and visual odometry circuitry 116. As used herein, an edge is an abstract object connecting two points on the image.

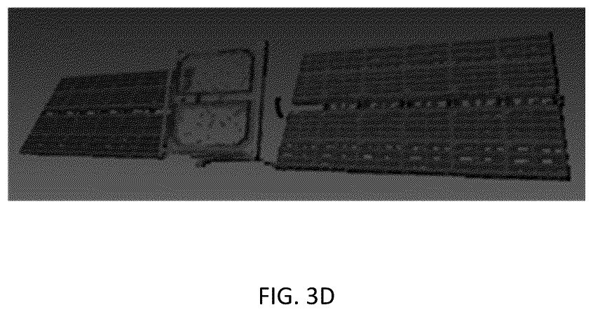

The stereo images from the image capture-1 102 and the image capture-2 104 are provided to the image processing circuitry 114 from the buffer memory 106 as a sequential flow of consecutive images. Image processing circuitry 114 is further described in FIG. 4 below. The results of the image processing circuitry 114 may be stored in the buffer memory 106 until retrieved by the visual odometry circuitry 116.

In an embodiment, the localization circuitry 110 calculates Jacobian and Hessian matrices analytically using the outputs of the image processing algorithm. The Jacobian matrix and Hessian matrix are then used as inputs to the convex optimization circuitry 120 which is iteratively applied to minimize the Huber loss of lighting intensities and calculate the change in translation and rotation between the current image and the previous image. In an embodiment, the convex optimization circuitry 120 may use a Levenberg-Marquardt optimization which optimizes the translation and rotation used to project the previous points into the current image using the most recent state estimation as the initialization.

In some embodiments, the convex optimization circuitry 120 may be external to the localization circuitry 110. In some other embodiments, the convex optimization circuitry 120 may be incorporated into the localization circuitry 110.

The challenge to overcome is creating a visual SLAM algorithm that can operate on objects and environments with limited unique features, is computationally efficient, and provides highly precise positional information. The target use case for this disclosure was for tracking satellites, but this system and method were designed and tested for a wide range of visual environments. Although a typical SLAM localization includes visual odometry, bundle adjustment, and loop closure, the disclosed system and method are targeted primarily to the visual odometry of the localization.

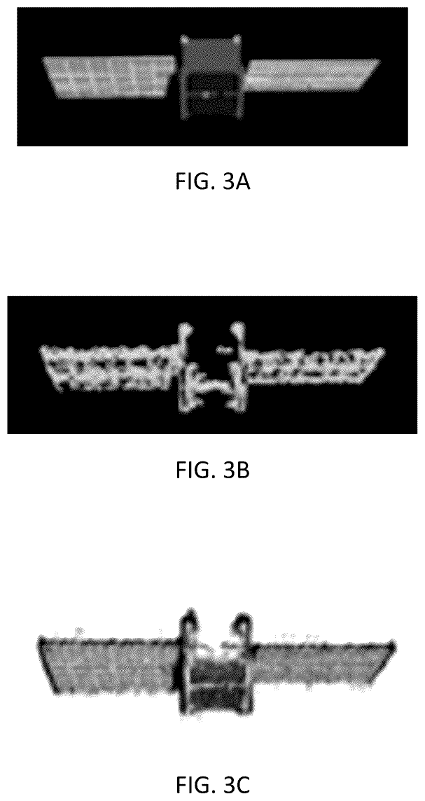

To overcome the problem of limited unique features, the disclosed system uses a direct SLAM algorithm over the more commonly used indirect SLAM algorithm. Traditional indirect SLAM algorithms rely on finding unique corners in an image and then using a feature descriptor that can then be used to match a corner pixel from one image to a corner pixel in another image where the scene has changed. This approach works well when most of the corners are visually unique, but for tracking artificial objects with many repeated and non-unique features, this type of approach performs poorly. FIG. 3 shows attempting to match two consecutive satellite images using a standard indirect algorithm SIFT with brute force matching. The green lines show the points matched between the current image, which is shown, and the previous image being matched to. Good matching, which is needed to use indirect SLAM, would require that a plurality of the points be matched properly which is difficult when there are such many similar looking features in the image, such as on the solar panels.

Instead of matching unique features using indirect descriptors, another approach is to align successive images together by aligning the direct lighting values of the pixels in the image. This is the direct approach, which operates directly on the image values instead of matching indirect feature descriptors. This direct method is much more robust to repeated features since it only focuses on aligning lighting intensities between images. The direct method also has the added benefit that it can use pixels from corners, edges, and flat planes with sufficient gradients to align the two images. This is contrasted to the indirect method which can only use pixels from corners. This greatly increases the total number of pixels that can be used and allows for a more evenly distributed set of points increasing the robustness of the direct method.

To help address the computation constraints, the disclosed system uses a sparse computation approach. Sparse computation is commonly used in SLAM algorithms where real time processing is used because not every pixel in the image is used to compute the SLAM algorithm. The alternative to sparse SLAM is the use of dense SLAM algorithms. These algorithms can provide more robust and more accurate data, but that comes at an extreme increase in computational requirements. For the illustrative example embodiment disclosed herein, 500 points are used for each image, which for a 640×480 image is a 618× sparsity.

In an embodiment, the disclosed SLAM algorithm uses two cameras for stereo depth estimation. SLAM algorithms need to calculate the 3D depth of each pixel to properly navigate and characterize the environment. With a single camera, these depth values can only be estimated. While approaches to estimate depth using a single camera have advanced in recent years, they tend to be less accurate than using a stereo pair of cameras. Stereo cameras calculate the depth of pixels based on how much the pixels in the image have moved from the left and right camera pair. This provides much more accurate depth estimations but does result in a higher SWAP by having an additional camera and having to process an additional camera stream. For the disclosed system, the additional SWAP of an extra camera was deemed necessary due to the high risk of incorrectly estimating depth and causing damage to a spacecraft due to incorrect location information.

The direct-sparse SLAM algorithm disclosed herein is inspired by a Stereo Direct Sparse Odometry (Stereo DSO) algorithm. The inputs of this algorithm are sequential images from two stereo aligned cameras and the output of this algorithm is the change in x, y, and z translation and rotation between each successive image pair.

FIGS. 3A-3D are an example of depth estimation using a stereo block matching algorithm consistent with the present disclosure. The disclosed SLAM is built on a direct SLAM method that relies on matching the lighting intensities between the two images, making it agnostic to the unique feature textures. FIGS. 3A-3C are images of the various steps in the direct SLAM algorithm. The image of FIG. 3A is the raw image; FIG. 3B is the depth map generated from the stereo pair images; and FIG. 3C conveys the current frame's points reprojected to the previous image. An example of the stereo output shown in FIG. 3D.

The first major part of the visual SLAM algorithm is the image processing stage. FIG. 4 is a functional block diagram of an illustrative example embodiment of the visual odometry circuitry 124 for the system 100 of FIG. 1 consistent with the present disclosure. This step operates over the dense images and produces sparse outputs which will then be used in the localization estimations.

This step calculates a depth map from the stereo pair of images 408, e.g., first image 402 and second image 404, a clipped x/y gradient 410 using a Sobel filter and calculates candidate edge locations 414 using the clipped x/y gradient 410 and a depth map 422 as input in deciding which sparse set of pixels to select from. In an embodiment, the first image 402 and the second image 404 may be images directly received from a pair of aligned cameras. In another embodiment, the first image 402 and the second image 404 may be images captured by remote cameras and sent to the visual odometry circuitry 124.

Besides the initial stereo calculations, in an embodiment all the processing is done on images that are down sampled by 2 in each dimension by resize-1 406 and resize-2 412. This downsizing is done to decrease the overall computation but may be removed in other embodiments if the input image is already a low image resolution or if additional computational power is available.

The second major part of the visual SLAM algorithm takes the resized images 416, X/Y gradients 418, sparse edge locations 420 and depth map 422 and optimizes the x, y, z translation and rotation values to align the previous edge pixels intensities with the current image pixel intensities. This step is accomplished using the convex optimization circuitry 120. In an embodiment, the convex optimization circuitry 120 may be a Levenberg-Marquardt optimization which optimizes the translation and rotation used to project the previous points into the current image using the most recent state estimation as the initialization.

The newly projected edge locations from the previous image are then compared to the current image pixel intensities using Huber loss. The Huber loss is used since it is more robust to outliers than a typical sum-squared error criterion. The Jacobian and Hessian matrices are then calculated analytically (with respect to the linearization about the current parameter values) using the outputs of the image processing algorithm. The Huber loss, Jacobian matrix, and Hessian matrix are then used as inputs to the convex optimization circuitry 120 which is iteratively applied to minimize the Huber loss of lighting intensities and calculate the change in translation and rotation between the current image and the previous image.

The choice of compute platform to run the direct-sparse algorithm drastically affects the overall SWAP of the algorithm. There are three main types of computational platforms that can be targeted, a Central Processing Unit (CPU), a Graphics Processing Unit (GPU), or a Field Programmable Gate Array (FPGA). For the CPU, the computational efficiency is the lowest, but it has the lowest coding complexity, meaning it is easy to design for, and has a high degree of space heritage as most space craft use a CPU. The GPU is a commonly used compute platform for SLAM algorithms in terrestrial applications because of its medium coding complexity and medium computation efficiency, but this type of processor is less commonly used in space applications and therefore has much less space heritage. The final compute platform is the FPGA, which have the highest computational efficiency, which is primarily achieved by explicitly designing each part of the algorithms and leveraging the customizability that an FPGA provides. While this provides a performance increase over CPUs and GPUs, it also comes at the cost of being extremely difficult to design and test advanced algorithms on compared to CPUs and GPUs. In an embodiment, the disclosed system implements many of the key algorithms in a space rated FPGA such as the Kintex UltraScale FPGA manufactured by Advanced Micro Devices, Inc.

Due to time constraints, only the image processing and Jacobian/Hessian algorithms were designed, mapped, and profiled on a space rated FPGA. However, other embodiments may include an end-to-end implementation integrating these algorithms into a full working design. The system 100 of FIG. 1 illustrates a high-level diagram of the algorithms as well as how they exchange data on an FPGA for the localization algorithm.

The image processing algorithm consists of chains of computer vision algorithms which operate on every pixel of the incoming images. This type of processing works best with a dataflow architecture. A dataflow architecture is best used for algorithms where the output of one stage can be immediately used by the next stage of the algorithm and does not require random access of data to compute the algorithm. This type of architecture removes the need for saving off intermediate values and allows for strong pipelining of the system reducing the overall computation time on an FPGA.

The results of the image processing step are stored in the buffer memory 106 connected to the FPGA. Storing the results of the image processing in RAM instead of in memory on the FPGA has two main benefits. First, it saves on FPGA resources. Many FPGA resources would have to be used to store the intermediate values needed for the Jacobian/Hessian algorithm. This could work well for smaller images but would become more prohibitive as the image sizes increase. Second, using FPGA memory resources would only have enough space to store a single previous image. This would be insufficient for the future desires of implementing the mapping algorithm of the visual SLAM which requires a long history of data to build a map over time.

The analytical Jacobian and Hessian calculation in the localization circuitry 110 operates on a sparse subset of the full image. The number of sparse points used in this calculation can be varied, with this embodiment using 500 points as the default. This sparse data is extracted from the buffer memory 106 with each edge pixel used in the calculation and averaged to produce the resulting Jacobian/Hessian matrixes in the localization circuitry 110 needed for the convex optimization circuitry 120.

Due to the constraints of testing in actual space conditions, this disclosure focused more on proof of concept than exhaustively evaluating the accuracy of the algorithm. To demonstrate basic generalizability, two use cases were evaluated. The first use case evaluated was a constant rotation simulated satellite. The second test case was a real-world ground vehicle going around a test track with known ground truth localization. In an embodiment, with each algorithm running in parallel, the system may run at 30 hertz (Hz), which is the standard max frame rate for most cameras. In other embodiments, the algorithms may run at a slower rate of 10 Hz or lower allowing for slower clock rates to be used, with a resulting power savings.

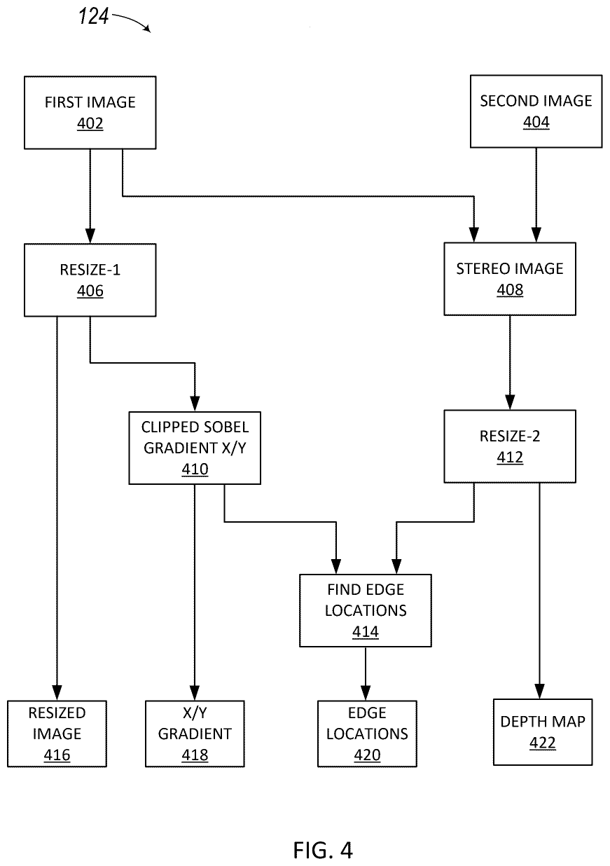

FIG. 5 shows the results of the disclosed SLAM algorithm running on a simulated video of a satellite with constant rotation with a resolution of 1920×1080 pixels. This example had the satellite rotate along a single axis (shown in orange) at a constant rate with all other rotations and translations held constant. A constant rotation is an expected test case for a satellite that has no onboard propulsion, with the test simulation doing a constant rotation of one degree per second about the y-axis.

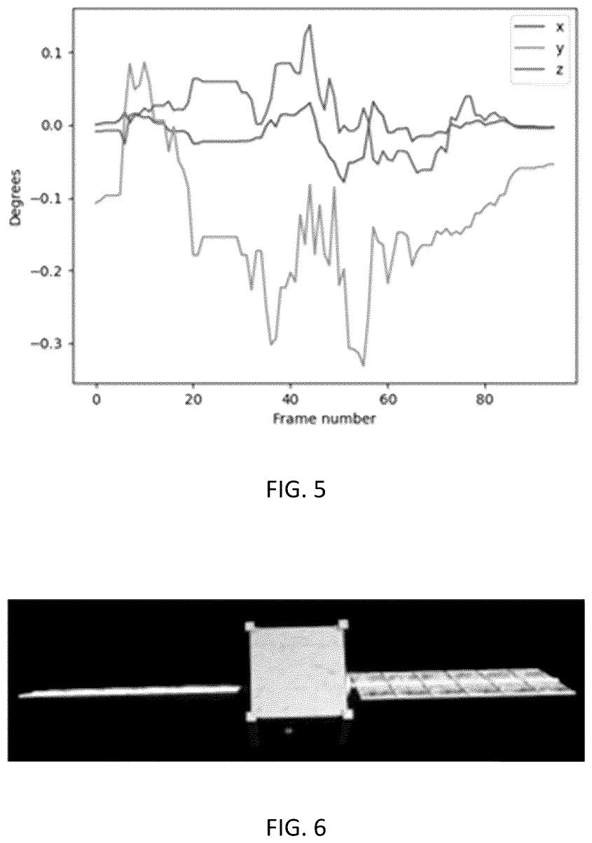

These results are the raw output of the localization algorithm which can predict the constant rotation for most of the image. This algorithm has noise which occurs at the end of the video when the solar panels are in their smallest visual profile to the camera as shown in FIG. 6. This causes a dramatic decrease in the number of detectable edges causing a less accurate prediction. These results can be further cleaned up with a median filter to achieve the desired rotation since it is known that the satellite will be moving at a constant speed.

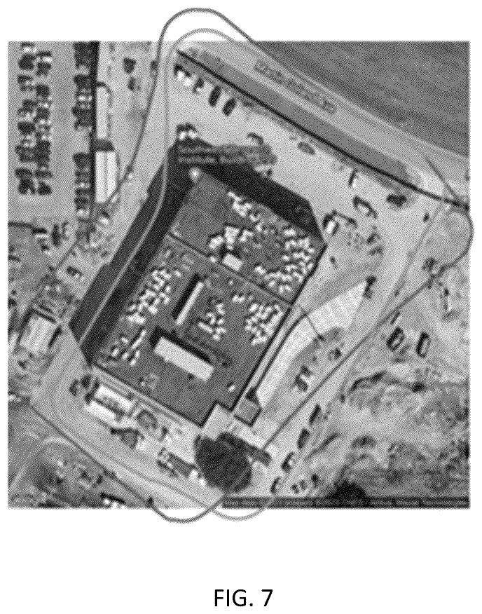

FIG. 7 illustrates the results from running the SLAM algorithm on data collected from a ground vehicle driving around a building. This data shows the ground truth path in orange and the estimated path from this SLAM algorithm in blue. The estimated blue line was obtained using the localization algorithm without the addition of other algorithms typically used in SLAM algorithm. While it is expected that these results can be improved by adding additional known SLAM algorithms along with the localization, this result shows that the direct-sparse algorithm has potential for generalizing to other space related applications such as autonomous vehicle in terrestrial applications.

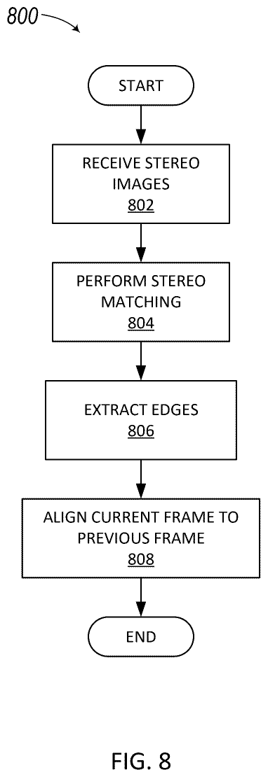

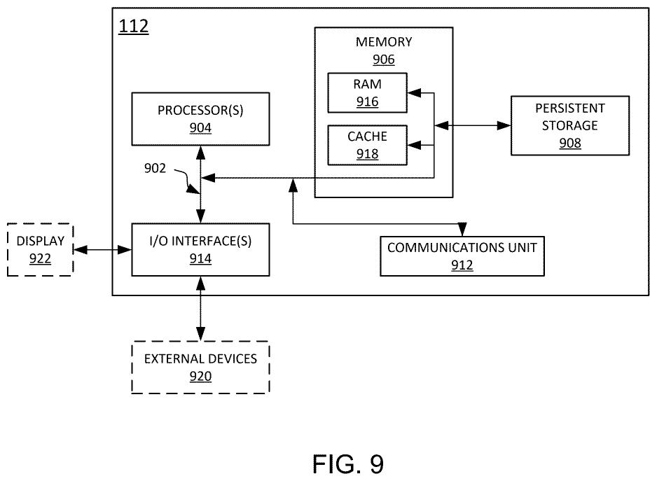

FIG. 8 is a flowchart diagram 800 depicting operations for lightweight simultaneous location and mapping on spacecraft to determine structure and pose, on the system of FIG. 1, consistent with the present disclosure. It should be appreciated that embodiments of the present disclosure provide at least for lightweight SLAM on spacecraft to determine structure and pose. However, FIG. 9 provides only an illustration of one implementation and does not imply any limitations with regard to the environments in which different embodiments may be implemented. Many modifications to the depicted environment may be made by those skilled in the art without departing from the scope of the disclosure as recited by the claims.

Receive stereo images (operation 802). In the illustrated example embodiment, a sequence of consecutive synchronized stereo images are received. In an embodiment, the synchronized stereo images may be received from a pair of cameras.

Perform stereo matching (operation 804). In this operation, the system identifies corresponding pixels between the two synchronized stereo images received in operation 802 that are taken from slightly different viewpoints by determining the disparity (horizontal shift) between matching pixels in the left and right images.

Extract edges (operation 806). In this operation, a depth map is calculated from the stereo pair of images, a clipped x/y gradient, using a Sobel filter and candidate edge locations are calculated using the gradient and depth map as input in deciding which sparse set of pixels to select from.

In an embodiment, operations 802, 804, and 806 may be performed by the image processing circuitry 108 from FIG. 1.

Align current frame to previous frame (operation 808). In this operation, successive images are aligned together by aligning the direct lighting values of the pixels in the image.

In an embodiment, operation 808 may be performed by the convex optimization circuitry 120 from FIG. 1.

If additional images to be processed are received, the procedure returns to operation 802 to continue processing the image data.

FIG. 9 is a block diagram depicting components of one example of the computing device 112 suitable for lightweight simultaneous location and mapping on spacecraft to determine structure and pose, within the system of FIG. 1, consistent with the present disclosure. FIG. 9 displays the computing device or computer 112, one or more processor(s) 904 (including one or more controllers or computer processors), a communications fabric 902, a memory 906 including, a random-access memory (RAM) 916 and a cache 918, a persistent storage 908, a communications unit 912, I/O interfaces 914, a display 922, and external devices 920. It should be appreciated that FIG. 9 provides only an illustration of one embodiment and does not imply any limitations with regard to the environments in which different embodiments may be implemented. Many modifications to the depicted environment may be made.

As depicted, the computer 900 operates over the communications fabric 902, which provides communications between the computer processor(s) 904, memory 906, persistent storage 908, communications unit 912, and input/output (I/O) interface(s) 914. The communications fabric 902 may be implemented with an architecture suitable for passing data or control information between the processors 904 (e.g., microprocessors, communications processors, and network processors), the memory 906, the external devices 920, and any other hardware components within a system. For example, the communications fabric 902 may be implemented with one or more buses.

The memory 906 and persistent storage 908 are computer readable storage media. In the depicted embodiment, the memory 906 comprises a RAM 916 and a cache 918. In general, the memory 906 can include any suitable volatile or non-volatile computer readable storage media. Cache 918 is a fast memory that enhances the performance of processor(s) 904 by holding recently accessed data, and near recently accessed data, from RAM 916.

Operations for lightweight simultaneous location and mapping on spacecraft to determine structure and pose may be stored in the persistent storage 908, or more generally, any non-transitory computer readable storage media, for execution by one or more of the respective computer processors 904 via one or more memories of the memory 906. The persistent storage 908 may be a magnetic hard disk drive, a solid-state disk drive, a semiconductor storage device, flash memory, read only memory (ROM), electronically erasable programmable read-only memory (EEPROM), or any other computer readable storage media that is capable of storing program instruction or digital information.

The media used by persistent storage 908 may also be removable. For example, a removable hard drive may be used for persistent storage 908. Other examples include optical and magnetic disks, thumb drives, and smart cards that are inserted into a drive for transfer onto another computer readable storage medium that is also part of persistent storage 908.

The communications unit 912, in these examples, provides for communications with other data processing systems or devices. In these examples, the communications unit 912 includes one or more network interface cards. The communications unit 912 may provide communications through the use of either or both physical and wireless communications links. In the context of some embodiments of the present disclosure, the source of the various input data may be physically remote to the computer 900 such that the input data may be received, and the output similarly transmitted via the communications unit 912.

The I/O interface(s) 914 allows for input and output of data with other devices that may be connected to computer 900. For example, the I/O interface(s) 914 may provide a connection to external device(s) 920 such as a keyboard, a keypad, a touch screen, a microphone, a digital camera, and/or some other suitable input device. External device(s) 920 can also include portable computer readable storage media such as, for example, thumb drives, portable optical or magnetic disks, and memory cards. Software and data used to practice embodiments of the present disclosure can be stored on such portable computer readable storage media and can be loaded onto persistent storage 908 via the I/O interface(s) 914.

I/O interface(s) 914 may also connect to a display 922. Display 922 provides a mechanism to display data to a user and may be, for example, a computer monitor. Display 922 can also function as a touchscreen, such as a display of a tablet computer.

According to one aspect of the disclosure there is thus provided a system for lightweight simultaneous location and mapping (SLAM) on spacecraft to determine structure and pose, the system including: one or more image capture devices; a buffer memory; a computing device; image processing circuitry; visual odometry circuitry; and convex optimization circuitry. The system is configured to: receive a plurality of synchronized images from each of the one or more image capture devices; convert the plurality of synchronized images into a plurality of pairs of stereo images; perform stereo matching of the plurality of pairs of stereo images; extract edges from the plurality of pairs of stereo images; and align a current frame to a previous frame.

According to another aspect of the disclosure, there is provided a method for lightweight simultaneous location and mapping (SLAM) on spacecraft to determine structure and pose, the method including: receiving a plurality of synchronized images from one or more image capture devices; converting the plurality of synchronized images into a plurality of pairs of stereo images; performing stereo matching on the plurality of pairs of stereo images; extracting edges from the plurality of pairs of stereo images; and aligning a current frame from the plurality of pairs of stereo images to a previous frame from the plurality of pairs of stereo images.

According to yet another aspect of the disclosure, there is provided a system for lightweight simultaneous location and mapping (SLAM) on spacecraft to determine structure and pose, the system including one or more image capture devices and a field programmable gate array (FPGA), The FPGA further including: a computing device; image processing circuitry; visual odometry circuitry; and convex optimization circuitry. The FPGA is configured to: receive a plurality of synchronized images from each of the one or more image capture devices; convert the plurality of synchronized images into a plurality of pairs of stereo images; perform stereo matching of the plurality of pairs of stereo images; extract edges from the plurality of pairs of stereo images; and align a current frame to a previous frame.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art. Also, it may be appreciated that the phraseology and terminology used herein is for the purpose of description and should not be regarded as limiting as such may be understood by one of skill in the art. Throughout the present disclosure, like reference characters may indicate like structure throughout the several views, and such structure need not be separately discussed. Furthermore, any particular feature(s) of a particular exemplary embodiment may be equally applied to any other exemplary embodiment(s) of this disclosure as suitable. In other words, features between the various exemplary embodiments described herein are interchangeable, and not exclusive.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The term “coupled” as used herein refers to any connection, coupling, link, or the like by which signals carried by one system element are imparted to the “coupled” element. Such “coupled” devices, or signals and devices, are not necessarily directly connected to one another and may be separated by intermediate components or devices that may manipulate or modify such signals.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems. Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system or a method. The system may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in one or more non-transitory computer readable storage media within the respective computing/processing device.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or other Programmable Logic Devices (PLD) may execute the computer readable program instructions by utilizing state information of the computer readable program instructions to personalize the electronic circuitry, in order to perform aspects of the present disclosure.

It will be appreciated by those skilled in the art that any block diagrams herein represent conceptual views of illustrative circuitry embodying the principles of the disclosure. Similarly, it will be appreciated that any block diagrams, flow charts, flow diagrams, state transition diagrams, pseudocode, and the like represent various processes which may be substantially represented in computer readable medium and so executed by a computer or processor, whether or not such computer or processor is explicitly shown. Software modules, or simply modules which are implied to be software, may be represented herein as any combination of flowchart elements or other elements indicating performance of process steps and/or textual description. Such modules may be executed by hardware that is expressly or implicitly shown.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A system for lightweight simultaneous location and mapping (SLAM) on spacecraft to determine structure and pose, the system comprising:
one or more image capture devices;
a computing device;
image processing circuitry;
visual odometry circuitry; and
convex optimization circuitry;
the system configured to:
receive a plurality of synchronized images from each of the one or more image capture devices;
convert the plurality of synchronized images into a plurality of pairs of stereo images;
perform stereo matching of the plurality of pairs of stereo images;
extract edges from the plurality of pairs of stereo images; and
align a current frame to a previous frame.

2. The system of claim 1, wherein the image processing circuitry configured to:
downsize the plurality of pairs of stereo images;
calculate a depth map from each pair of the plurality of pairs of stereo images;
calculate a clipped x/y gradient; and
calculate one or more candidate edge locations for each pair of the plurality of pairs of stereo images.

3. The system of claim 2, wherein the clipped x/y gradient is calculated using a Sobel filter.

4. The system of claim 1, further comprising a buffer memory.

5. The system of claim 1, wherein the convex optimization circuitry further comprises:
a Levenberg-Marquardt optimization, the convex optimization circuitry further configured to:
iteratively apply the Levenberg-Marquardt optimization to minimize a Huber loss of lighting intensities; and
calculate a change in translation and rotation between a current image of the plurality of pairs of stereo images and a previous image of the plurality of pairs of stereo images.

6. The system of claim 5, wherein the image processing circuitry further configured to:
calculate a Jacobian matrix and a Hessian matrix for each pair of the plurality of pairs of stereo images.

7. The system of claim 6, wherein align the current frame to the previous frame using the convex optimization circuitry further comprises:
align successive images together by aligning a direct lighting values of a first one or more pixels in the current frame to a second one or more pixels in the previous frame using the Huber loss, the Jacobian matrix, and the Hessian matrix.

8. The system of claim 2, wherein calculate the one or more candidate edge locations for each pair of the plurality of pairs of stereo images further comprises:
calculate the one or more candidate edge locations for each pair of the plurality of pairs of stereo images using the clipped x/y gradient and the depth map.

9. A method for lightweight simultaneous location and mapping (SLAM) on spacecraft to determine structure and pose, the method comprising:
receiving a plurality of synchronized images from one or more image capture devices;
converting the plurality of synchronized images into a plurality of pairs of stereo images;
performing stereo matching on the plurality of pairs of stereo images;
extracting edges from the plurality of pairs of stereo images; and
aligning a current frame from the plurality of pairs of stereo images to a previous frame from the plurality of pairs of stereo images.

10. The method of claim 9, further comprising:
downsizing the plurality of pairs of stereo images;
calculating a depth map from each pair of the plurality of pairs of stereo images;
calculating a clipped x/y gradient; and
calculating one or more candidate edge locations for each pair of the plurality of pairs of stereo images.

11. The method of claim 10, wherein the clipped x/y gradient is calculated using a Sobel filter.

12. The method of claim 9, further comprising:
iteratively apply a Levenberg-Marquardt optimization to minimize a Huber loss of lighting intensities; and
calculating a change in translation and rotation between a current image of the plurality of pairs of stereo images and a previous image of the plurality of pairs of stereo images.

13. The method of claim 12, wherein aligning the current frame from the plurality of pairs of stereo images to the previous frame from the plurality of pairs of stereo images further comprises:
aligning successive images together by aligning a direct lighting values of a first one or more pixels in the current frame to a second one or more pixels in the previous frame using the Huber loss, a Jacobian matrix and a Hessian matrix.

14. The method of claim 10, wherein calculating the one or more candidate edge locations for each pair of the plurality of pairs of stereo images further comprises:
calculating the one or more candidate edge locations for each pair of the plurality of pairs of stereo images using the clipped x/y gradient and the depth map.

15. A system for lightweight simultaneous location and mapping (SLAM) on spacecraft to determine structure and pose, the system comprising:
one or more image capture devices;
a field programmable gate array (FPGA), the FPGA further comprising:
a computing device;
image processing circuitry;
visual odometry circuitry; and
convex optimization circuitry;
the FPGA configured to:
receive a plurality of synchronized images from each of the one or more image capture devices;
convert the plurality of synchronized images into a plurality of pairs of stereo images;
perform stereo matching of the plurality of pairs of stereo images;
extract edges from the plurality of pairs of stereo images; and
align a current frame to a previous frame.

16. The system of claim 15, wherein the current frame is aligned to the previous frame at a rate of at least 10 hertz.

17. The system of claim 15, wherein the image processing circuitry configured to:
downsize the plurality of pairs of stereo images;
calculate a depth map from each pair of the plurality of pairs of stereo images;
calculate a clipped x/y gradient; and
calculate one or more candidate edge locations for each pair of the plurality of pairs of stereo images using the clipped x/y gradient and the depth map.

18. The system of claim 17, wherein the clipped x/y gradient is calculated using a Sobel filter.

19. The system of claim 15, further comprising a buffer memory.

20. The system of claim 15, wherein the convex optimization circuitry further comprises:
a Levenberg-Marquardt optimization, the convex optimization circuitry further configured to:
iteratively apply the Levenberg-Marquardt optimization to minimize a Huber loss of lighting intensities; and
calculate a change in translation and rotation between a current image of the plurality of pairs of stereo images and a previous image of the plurality of pairs of stereo images.
